(19) United States
(12) Patent Application Publication
(10) Pub. No.: US 2017/0347027 A1
(43) Pub. Date: Nov. 30, 2017

(54) CAMERA DEVICE

(71) Applicant: Jason Fudge, Steeleville, IL (US)

(72) Inventor: Jason Fudge, Steeleville, IL (US)

(21) Appl. No.: 15/605,941

(22) Filed: May 25, 2017

Related U.S. Application Data
(60) Provisional application No. 62/342,738, filed on May 27, 2016.

(51) Int. Cl. H04N 5/232; H04N 5/907; H04N 5/225; G03B 17/56; F16M 11/18; H04N 7/18; F16M 11/08

(52) U.S. Cl. CPC H04N 5/23238; H04N 7/188; H04N 5/907; H04N 5/23245; F16M 11/08; G03B 17/568; G03B 17/561; F16M 11/18; H04N 5/2252

(57) ABSTRACT

An improved camera device is a 360-degree image capturing camera with a motion sensor that is able to take panoramic view pictures. The main body is circular shaped and may be able to rotate on a central axis to align with the direction of anything that activates the motion sensor for optimal images or video.

### CROSS-REFERENCE TO RELATED APPLICATION

The present application is related to and claims priority from prior provisional application Ser. No. 62/342,738, filed May 27, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of motion sensing cameras and more specifically relates to an improved camera device.

### 2. Description of the Related Art

A camera is an optical instrument for recording or capturing images which may be stored locally in a memory device within the camera, and then is able to transfer the images taken to another location or device either wirelessly or by direct connection using a data cable or wire. The images may be individual still photographs, sequences of images, or streaming images such as with video or surveillance cameras. Surveillance cameras have been developed to be placed in locations where the images of someone involved in an illegal activity may be captured for the protection of a business or residence. Often these cameras are obvious to anyone nearby and work also as a deterrent to crime. Other times they are disguised or hidden so that criminal activity doesn't involve removing the camera and/or the memory device.

In recent years, the idea of using a camera in remote areas for recording wild game that may inhabit the area for hunting purposes has become feasible and popular. These cameras work fairly well in that they have motion sensors that activate the camera to take a series of photographs or a short video when something activates the motion sensor. These cameras are relatively expensive considering they are limited to only one type of use. This is also true when it is taken into consideration that the field of view is very narrow and the user must decide what direction to position the camera to capture the desired images. For instance, when setting the camera up as a game camera, the camera will usually be attached to a vertical structure such as a tree and then pointed in the direction that the user thinks will most likely capture moving animals. The inadequacies of this are obvious when the pictures are downloaded and small portions of something moving is captured and not enough of it to even determine what it was. It also goes to reason that the remainder of the 360 degree field of view could have had any number or type of moving animals in it that could not be seen by the camera. A new innovation is needed to address these inadequacies of existing motion detecting cameras.

Various attempts have been made to solve the above-mentioned problems such as those found in U.S. Pat. No. 5,878,283 to House et al; U.S. Patent No. 2007/0182819 to David Monroe; and U.S. Publication No. 2012/0320150 to Myles Montgomery. This art is representative of motion sensing cameras. None of the above inventions and patents, taken either singly or in combination, is seen to describe the invention as claimed.

Ideally, a motion sensing camera should provide a 360 degree viewing angle, and yet, would operate reliably and be manufactured at a modest expense. Thus, a need exists for a reliable improved camera device to avoid the above-mentioned problems.

### BRIEF SUMMARY OF THE INVENTION

In view of the foregoing disadvantages inherent in the known motion sensing camera art, the present invention provides a novel improved camera device. The general purpose of the present invention, which will be described subsequently in greater detail, is to provide a 360 degree viewing angle.

The improved camera device preferably comprises a main body, a camera apparatus with at least one lens member that is attached to the main body and is adapted to record visual images in a 360 degree array surrounding the main body, a motion detector attached to the main body adapted to detect motion within a predetermined range of the main body and activate the camera apparatus, a memory storage card removably connected to the main body that is adapted to store the visual images from the camera apparatus thereon, and a power supply attached to the main body that is electrically connected to the camera apparatus, the motion detector, and the memory storage card to provide power thereto.

The visual images include videos and still pictures and the memory storage card is adapted to store up to 32 gigabytes of the visual images. The power supply is preferably formed as rechargeable batteries.

The camera apparatus further may include an axle member attached within the main body, a housing rotatably attached to the axle member that encases and holds the lens member therein, and a motor member connected between the axle member and the housing that is adapted to rotate the housing around the axle member. The motion detector is adapted to sense motion and communicate with the motor member to rotate the housing to point the lens member toward where the motion was detected. The lens member may be formed as a panoramic lens member adapted to record images in a 360 degree array.

A computer circuit board may be connected to the main body that is electrically connected to the camera apparatus, the motion detector, the memory storage card, the power source, and a control panel. The control panel may be connected to the outer surface of the main body and is electrically connected to the camera apparatus, the motion detector, the memory storage card, the power source, and the computer circuit board and is adapted to allow a user to manually control and to program the improved camera device to run autonomously. The control panel is preferably adapted to allow a user to input the predetermined range of the motion detector and to allow a user to input predetermined periods that the camera apparatus records the visual images.

The main body is formed from a material chosen from the list of materials consisting of stainless steel, ceramic, and plastic. The control panel may include a liquid crystal display member. The main body includes a screw insert adapted to releasably receive a screw member adapted to connect the improved camera device to a support member and have a memory card slot for releasably engaging the memory storage card. The main body may include an outer surface that is adapted to camouflage the improved camera device within its surroundings.

The present invention holds significant improvements and serves as an improved camera device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved camera device, constructed and operative according to the teachings of the present invention.

FIG. 1 shows a perspective view illustrating an in-use condition of an improved camera device according to an embodiment of the present invention.

FIG. 2 is a perspective view illustrating the improved camera device according to an embodiment of the present invention of FIG. 1.

FIG. 3 is a perspective view illustrating the improved camera device according to an embodiment of the present invention of FIG. 1.

FIG. 4 is a perspective view illustrating the improved camera device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a motion sensing camera and more particularly to an improved camera device as used to improve the field of view to a 360 degree viewing angle.

Generally speaking, a improved camera device is a 360 degree image capturing camera with a motion sensor that is able to take panoramic view pictures. The main body is circular shaped and may be able to rotate on a central axis to align with the direction of anything that activates the motion sensor for optimal images or video.

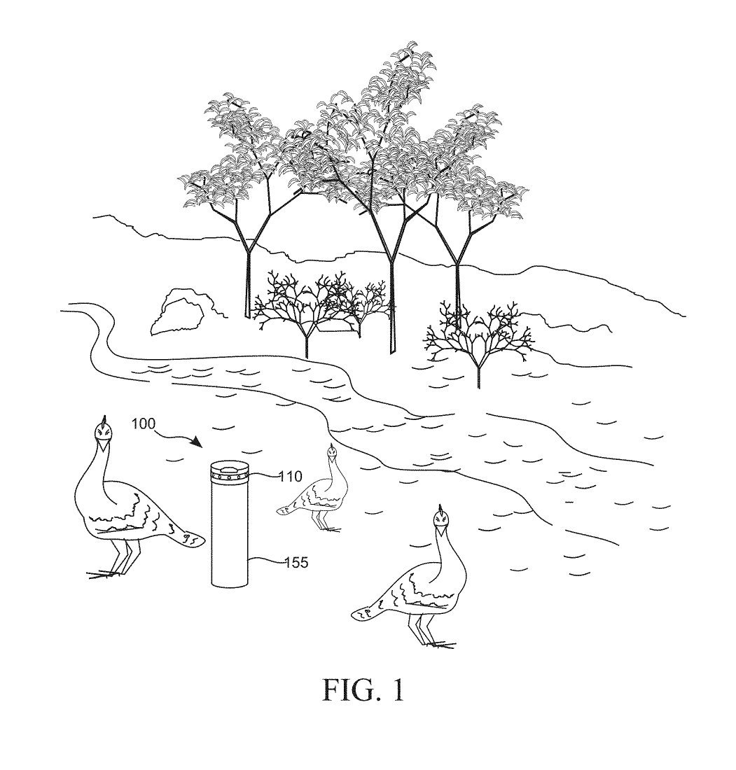

In greater detail now, referring to the drawings by numerals of reference there is shown in FIG. 1, a perspective view illustrating an in-use condition of improved camera device 100 according to an embodiment of the present invention.

The general purpose of the present invention described subsequently in greater detail, is to provide a 360-degree field of view improved camera device 100 for detecting any game, intruder, or trespasser within a 360-degree circumference of improved camera device 100. Improved camera device 100 contains motion detector 115, lens member 111, and memory storage card 120, and power supply 125. Motion detector 115 is designed to detect any moving object within range and activate improved camera device 100. Lens member 111 is designed to capture video or pictures during daytime or nighttime and to switch to plot watcher during the daytime. Memory storage card 120 is capable of storing up to 32 gigabytes of video and picture data. Power supply 125 uses rechargeable batteries 126 to power camera apparatus 110. The visual images include videos and still pictures and memory storage card 120 is adapted to store up to 32 gigabytes of the visual images. Power supply 125 is preferably formed as rechargeable batteries 126.

Since improved camera device 100 has 360 degree viewing capability, it is mounted onto axle member 130 and may be deployed anywhere a good 360 degree field of view is available that won't place it in a path where damage could occur.

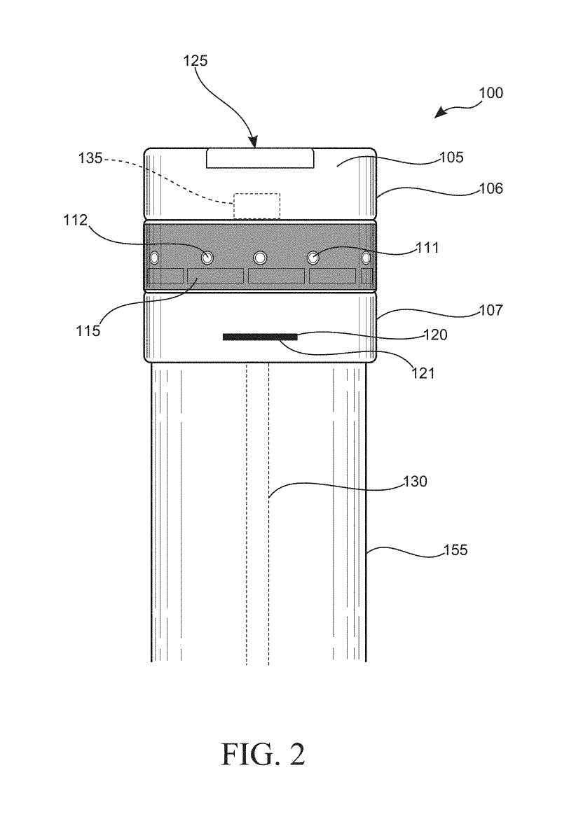

Referring now to FIG. 2, is a perspective view illustrating improved camera device 100 according to an embodiment of the present invention of FIG. 1.

Improved camera device 100 preferably comprises main body 105, camera apparatus 110 with at least one lens member 111 that is attached to main body 105 and is adapted to record visual images in a 360 degree array surrounding main body 105, motion detector 115 attached to main body 105 adapted to detect motion within a predetermined range of main body 105 and activate improved camera device 100, memory storage card 120 removably connected to main body 105 that is adapted to store the visual images from improved camera device 100 thereon, and power supply 125 attached to main body 105 that is electrically connected to improved camera device 100, motion detector 115, and memory storage card 120 to provide power thereto.

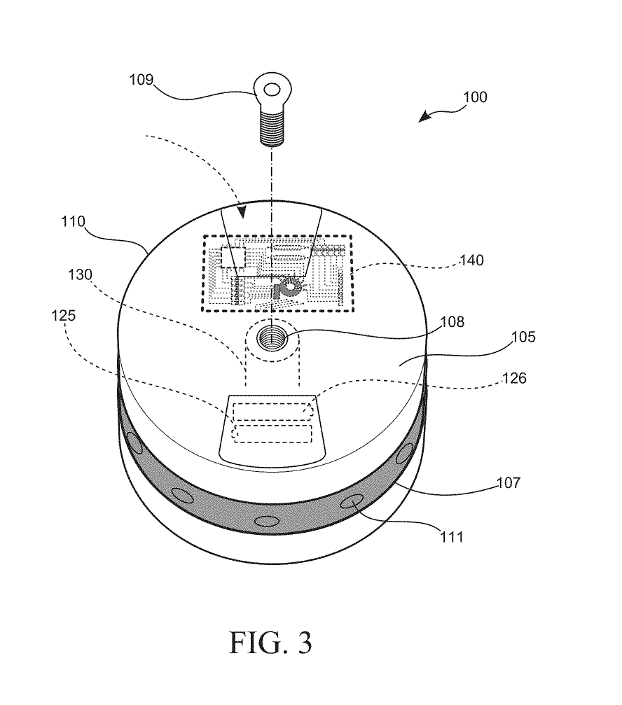

Referring now to FIG. 3, is a perspective view illustrating improved camera device 100 according to an embodiment of the present invention of FIG. 1.

Improved camera device 100 further may include axle member 130 attached within main body 105, housing 106 rotatably attached to axle member 130 that encases and holds lens member 111 therein, and motor member 135 connected between axle member 130 and housing 106 that is adapted to rotate housing 106 around axle member 130. Motion detector 115 is adapted to sense motion and communicate with motor member 135 to rotate housing 106 to point lens member 111 toward where the motion was detected. Lens member 111 may be formed as a panoramic lens member 111 adapted to record images in a 360 degree array.

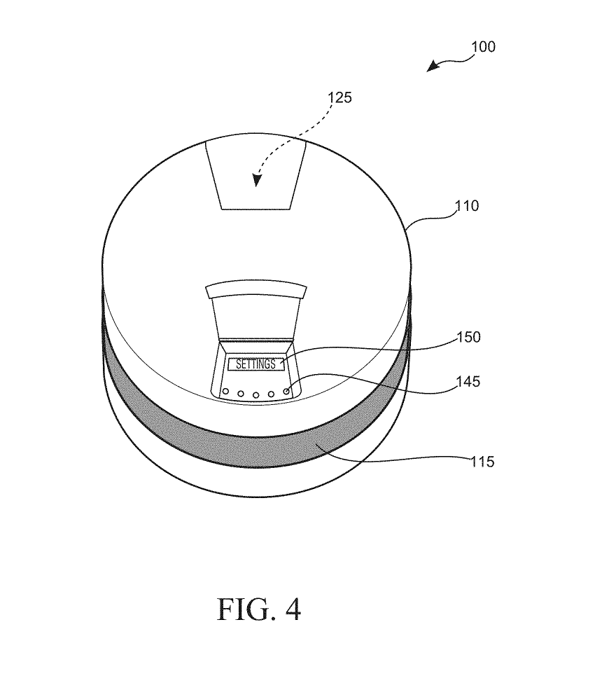

Referring now to FIG. 4, is a perspective view illustrating improved camera device 100 according to an embodiment of the present invention of FIG. 1.

Computer circuit board 140 may be connected to main body 105 that is electrically connected to camera apparatus 110, motion detector 115, memory storage card 120, power supply 125, and control panel 145. Control panel 145 may be connected to outer surface 107 of main body 105 and is electrically connected to camera apparatus 110, motion detector 115, memory storage card 120, power supply 125, and computer circuit board 140 and is adapted to allow a user to manually control and to program improved camera device 100 to run autonomously. Control panel 145 is preferably adapted to allow a user to input the predetermined range of motion detector 115 and to allow a user to input predetermined periods that improved camera device 100 records the visual images.

Main body 105 is formed from a material chosen from the list of materials consisting of stainless steel, ceramic, and plastic. Control panel 145 may include liquid crystal display member 150. Main body 105 includes screw insert 108 adapted to releasably receive screw member 109 adapted to connect improved camera device 100 to support member 155 and have memory card slot 121 for releasably engaging memory storage card 120. Main body 105 may include outer surface 107 that is adapted to camouflage improved camera device 100 within its surroundings.

Improved camera device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved camera device comprising:
a main body;
a camera apparatus including;
at least one lens member;
wherein said camera apparatus is attached to said main body and is adapted to record visual images in a 360 degree array surrounding said main body;
a motion detector;
wherein said motion detector is attached to said main body and is adapted to detect motion within a predetermined range of said main body and activate said camera apparatus;
a memory storage card;
wherein said memory storage card is removably connected to said main body and is adapted to store said visual images from said camera apparatus thereon; and
a power supply;
wherein said power supply is attached to said main body and is electrically connected to said camera apparatus, said motion detector, and said memory storage card to provide power thereto.

2. The improved camera device of claim 1, wherein said visual images includes videos and pictures.

3. The improved camera device of claim 1, wherein said memory storage card is adapted to store up to 32 gigabytes of said visual images.

4. The improved camera device of claim 1, wherein said power supply is formed as rechargeable batteries.

5. The improved camera device of claim 1, wherein said camera apparatus further includes:
an axle member;
wherein said axle member is attached within said main body;
a housing;
wherein said housing is rotatably attached to said axle member and encases and holds said lens member therein; and
a motor member;
wherein said motor member is connected between said axle member and said housing and is adapted to rotate said housing around said axle member.

6. The improved camera device of claim 5, wherein said motion detector is adapted to sense motion and communicate with said motor member to rotate said housing to point said lens member where said motion was detected.

7. The improved camera device of claim 1, wherein said lens member is formed as a panoramic lens member adapted to record images in a 360 degree array.

8. The improved camera device of claim 1, further comprising:
a computer circuit board;
wherein said computer circuit board is connected to said main body and is electrically connected to said camera apparatus, said motion detector, said memory storage card, and said power source; and
a control panel;
wherein said control panel is connected to an outer surface of said main body and is electrically connected to said camera apparatus, said motion detector, said memory storage card, said power source, and said computer circuit board; and
wherein said control panel is adapted to allow a user to manually control said improved camera device, and to program said improved camera device to run autonomously.

9. The improved camera device of claim 8, wherein said control panel is adapted to allow a user to input said predetermined range of said motion detector.

10. The improved camera device of claim 8, wherein said control panel is adapted to allow a user to input predetermined periods that said camera apparatus records said visual images.

11. The improved camera device of claim 1, wherein said main body if formed from a material chosen from a list of materials consisting of stainless steel, ceramic, and plastic.

12. The improved camera device of claim 8, wherein said control panel includes and liquid crystal display member.

13. The improved camera device of claim 1, wherein said main body includes a screw insert adapted to releasably receive a screw member adapted to connect said improved camera device to a support member.

14. The improved camera device of claim 1, wherein main body includes a memory card slot for releasably engaging said memory storage card.

15. The improved camera device of claim 1, wherein main body includes an outer surface that is adapted to camouflage said improved camera device within its surroundings.
